(19) United States
(12) Patent Application Publication
(10) Pub. No.: US 2006/0173997 A1
(43) Pub. Date: Aug. 3, 2006

(54) Method and apparatus for remote management of a monitoring system over the internet

(75) Inventors: Joacim Tullberg, Lund (SE); Johan Adolfsson, Sodra-Sandby (SE)

Correspondence Address: IP CREATORS, P. O. BOX 2789, CUPERTINO, CA, 95015, US

(73) Assignee: AXIS AB., Lund (SE)

(21) Appl. No.: 11/329,450

(22) Filed: Jan. 10, 2006

Related U.S. Application Data
(60) Provisional application No. 60/647,116, filed on Jan. 25, 2005.

(30) Foreign Application Priority Data
Jan. 10, 2005 (SE) 0500071-6

(51) Int. Cl. G06F 15/173

(52) U.S. Cl. 709/224

(57) ABSTRACT

A Monitoring system and a method in a monitoring system comprising a public network, a private network, an access limiting device arranged to limit the access of the private network from the public network, and a control server connected to the public network. The monitoring system further comprises a monitoring device connected to the private network and being arranged to send an HTTP request to the control server. The control server being arranged to send a HTTP response to the monitoring device in response to the HTTP request, wherein the HTTP header's ‘Content-Length’ field of the HTTP response is not defined or wherein the HTTP header's ‘Content-Length’ field is set to a number that is large enough to enable transport of a plurality of future control messages as part of an over time stretched HTTP response resulting in an open path from the control server to the monitoring device through the access limiting device and wherein the control server is arranged to send control messages to the monitoring device via said open path.

### CROSS REFERENCE TO RELATED APPLICATION

This application claims the benefit of prior filed co-pending Provisional Application No. 60/647,116 filed on Jan. 25, 2005 entitled “Monitoring System and Method for Accessing a Monitoring Device of a Monitoring System” (Atty. Docket # AWAPP012P) and of prior filed Swedish Patent Application No. 0500071-6 filed Jan. 10, 2005 entitled “Monitoring System and Method for Accessing a Monitoring Device of a Monitoring System” both of which are incorporated herein by reference in their entirety as if fully set forth herein.

### BACKGROUND OF THE INVENTION

1. Field of Invention

The present invention relates to a monitoring system including a public network, a private network, and an access limiting device arranged to limit the access of the private network from the public network. Further the present invention relates to a method for accessing a monitoring device of such a monitoring system from the public network.

2. Description of the Related Art

Monitoring systems for monitoring of premises, areas of particular interest and processes by means of cameras connected directly to computer networks are increasingly popular. One reason for this may be that these systems in great extent may utilize an existing network, if a computer network already is in place. Another reason may be that the network that has to be built for the monitoring system may be used to connect other types of equipment, e.g. computers, servers and peripherals.

In many cases the users of the monitoring system or a central control center responsible for the monitoring of the premises, areas of particular interest or processes are located remotely from the monitored site. As a result of the monitoring system being based on a computer network a remote user or a remote control center may be easily connected to the monitoring system via the Internet. However, most private networks, home networks, corporate networks, etc. are connected to the Internet via some device that limits the access to the network from the Internet. Such an access limiting device may be a firewall, a router implementing NAT (Network Address Translation) to provide additional IP addresses on the private network, a proxy server or an Internet Service Provider (ISP) providing dynamic IP-addresses.

Thus, one problem of such a monitoring system is that many functions, e.g. control of the monitoring device or devices, require transactions initiated by either the control center or the remote user and that the monitoring device or devices are arranged in a private network behind an access limiting device. Accordingly, the control center or the remote user either are unable to penetrate the protection installed or do not have knowledge of the address of the monitoring device or devices. A firewall may be modified to pass through communication originating from outside the private network. Such modifications may however be difficult, either because the firewall is not within the control of the user, because the user do not want to open the firewall, or because the user do not know how or do not want to go through the trouble of modifying the firewall.

One way of making it possible for servers to communicate with clients otherwise inaccessible is described in the patent application US 2004/0044771 A1. The document describes that a persistent network connection from the client to the server is established. Further, it describes that such a scheme may work fine for a small number of clients, but that the server will soon be overloaded for a large number (i.e. thousands or more) of clients connecting to a single server.

However, the document does not describe how to implement a persistent network connection to otherwise inaccessible network devices.

### SUMMARY OF THE INVENTION

One object of the present invention is to provide an improved computer network based monitoring system.

In particular, according to a first aspect of the invention, the object is accomplished by means of a method for accessing at least one monitoring device of a monitoring system wherein the monitoring system comprises a public network, a private network, an access limiting device arranged to limit the access to the private network from the public network, a monitoring device connected to the private network, and a control server connected to the public network. The method comprises sending a Hyper Text Transport Protocol (HTTP) request from the monitoring device to the control server, sending, in response to said HTTP request, an HTTP response in which the HTTP header's ‘Content-Length’ field is not defined or in which the HTTP header's ‘Content-Length’ field is set to a number that is large enough to enable transport of a plurality of future control messages as part of an over time stretched HTTP response, thereby achieving an open path from the server to the monitoring device through the access limiting device, and sending a plurality of control messages to the monitoring device from the control server via said open path.

According to a second aspect of the invention the object is accomplished by means of a monitoring system comprising a public network, a private network, an access limiting device arranged to limit the access of the private network from the public network, and a control server connected to the public network. The monitoring system being characterized by a monitoring device connected to the private network and being arranged to send an HTTP request to the control server, said control server being arranged to send a HTTP response to the monitoring device in response to the HTTP request, wherein the ‘Content-Length’ header field of the HTTP response is not defined or wherein the content length is set to a number that is large enough to enable transport of a plurality of future control messages as part of an over time stretched HTTP response resulting in an open path from the control server to the monitoring device through the access limiting device and wherein the control server is arranged to send control messages to the monitoring device via said open path.

One advantage of providing an open path from the control server to the monitoring device by means of responding to an http request with an HTTP response as described above is that the HTTP request is a type of message that almost always are allowed to be sent out through a firewall or any other access limiting device. Therefore, the creating of the open path by sending the HTTP request from the monitoring device to the control server and responding from the control server with said HTTP response results in a simple and effective way to create the open path through the access limiting device from the control server to the monitoring device. Accordingly, the setup of the monitoring system becomes simple because there is no need for tampering with access limiting devices in order to make control server initiated transactions possible. Especially, the setup of the monitoring device becomes simple and the security of the private network do need to be affected.

According to one embodiment the HTTP request initiating the setup of the open path is sent from the monitoring device as soon as a network connection is detected. This makes it even more simple to setup the monitoring devices. The simplicity of setting up the monitoring device may be particularly interesting for small business or monitoring systems for homes.

According to a further embodiment said HTTP request is sent to a control server indicated as a first choice in a list of control servers stored in the monitoring device. This feature also contribute to simplifying the installation of the monitoring device. Further, this may facilitate load control of the system.

According to yet a further embodiment the method further comprises the acts of:

sending a control message from a first server, which is currently enabled to send control messages to the monitoring device via the open path, wherein the control message includes instructions to the monitor device to move the open path from the first control server to a second control server,

terminating the connection that generated the open path and, thus, terminating the open path.

sending an HTTP request from the monitoring device to the second control server,

sending, in response to said HTTP request, an HTTP response from the second control server in which the content length is not defined, thereby achieving an open path from the second control server to the monitoring device through the access limiting device, and

sending a plurality of control messages to the monitoring device from the second control server via said open path after the HTTP response has been sent.

By providing a method like this it becomes possible to balance the network load of the system dynamically in spite of the fact that the monitoring device is arranged on a private network behind an access limiting device, i.e. if the load on the control server or on the public network path to the control server becomes to high.

According to a further embodiment the control server to move the open path to are selected by the monitoring device from a list of control servers stored in the monitoring device. The selected control server is then set to be the control server of first choice and the setting is stored in the list in the monitoring device. The advantage of this is that the risk of unnecessary load on the network or to specific servers are minimized, because the load of the control server initiating the move or the network path to that control server is probably high even after the monitoring device has been disconnected and reconnected, in which event the monitoring device will connect to a control server experiencing less load.

In an alternate embodiment of the invention a monitoring system configured to couple to a packet switched network supporting an HTTP protocol is disclosed. The monitoring system includes a control server and a monitoring device. The control server is configured to couple to the packet switched network and to respond to a sign in request from a monitoring device by maintaining an open connection therewith and further configured to respond to a data request from a network terminal for monitoring data from the monitoring device by sending over the open connection a response packet including a control message portion which includes an uniform resource locator identifying the monitoring data. The monitoring device configured to couple to the packet switched network and to send the sign in request to the control server and the monitoring device responsive to the receipt of the response packet from the control server to parse the control message portion and to open a new data transfer connection with the control server by sending an HTTP request which includes the monitoring data to the control server, whereby the requested monitoring data is uploaded to the control server for delivery to the terminal without a requirement of an HTTP request from the control server to the monitoring device.

In an alternate embodiment of the invention an apparatus configured to couple to a packet switched network which supports an HTTP protocol and which includes a control server is disclosed. The apparatus comprises a monitoring device configured to couple to the packet switched network and to issue a first HTTP request for sign in to the control server and the monitoring device responsive to the receipt of the response packet from the control server to parse a control message portion thereof which identifies monitoring data on the monitoring device for transfer to the control server and the monitoring device further responsive to open a new data transfer connection with the control server by sending a second HTTP request which includes the monitoring data to the control server, thereby avoiding any HTTP request from the control server to the monitoring.

In an alternate embodiment of the invention a method for transferring monitoring data over a packet switched network which includes a monitoring device, a control server and a terminal each of which supports an HTTP protocol is disclosed. The method includes the acts of:
sending from the monitoring device a first HTTP request for sign on to the control server;
sending from the terminal to the control server a second HTTP request for monitoring data on the monitoring device;
sending from the control server to the monitoring device an HTTP response to the first HTTP request which includes a control message portion identifying the monitoring data identified in the second request;
parsing the control message portion of the HTTP response packet on the monitoring device; and

sending from the monitoring device to the control server responsive to the parsing act, a third HTTP request which includes the monitoring data, whereby the requested monitoring data is uploaded to the control server for delivery to the terminal, thereby avoiding an HTTP request from the control server to the monitoring device.

A further scope of applicability of the present invention will become apparent from the detailed description given below. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Other features and advantages of the present invention will become apparent from the following detailed description of a presently preferred embodiment, with reference to the accompanying drawings, in which:

FIG. 1 is a network diagram of one embodiment of a monitoring system according to the present invention;

FIG. 2 is a timing diagram over one embodiment of the signaling between the monitoring device and the control server resulting in the open path;

FIG. 3 is a timing diagram presenting a possible signaling scheme for checking the open path;

FIG. 4 is a network diagram of an alternate embodiment of a monitoring system shown in FIG. 1;

FIG. 5 is a hardware and software block diagram of one embodiment of the monitoring device;

FIG. 6 is a hardware and software block diagram of one embodiment of the control server;

FIG. 7 is a process flow diagram of the processes executed in an embodiment of the monitoring device; and

FIG. 8 is a process flow diagram of the processes executed in an embodiment of the control server.

### DETAILED DESCRIPTION OF THE EMBODIMENTS

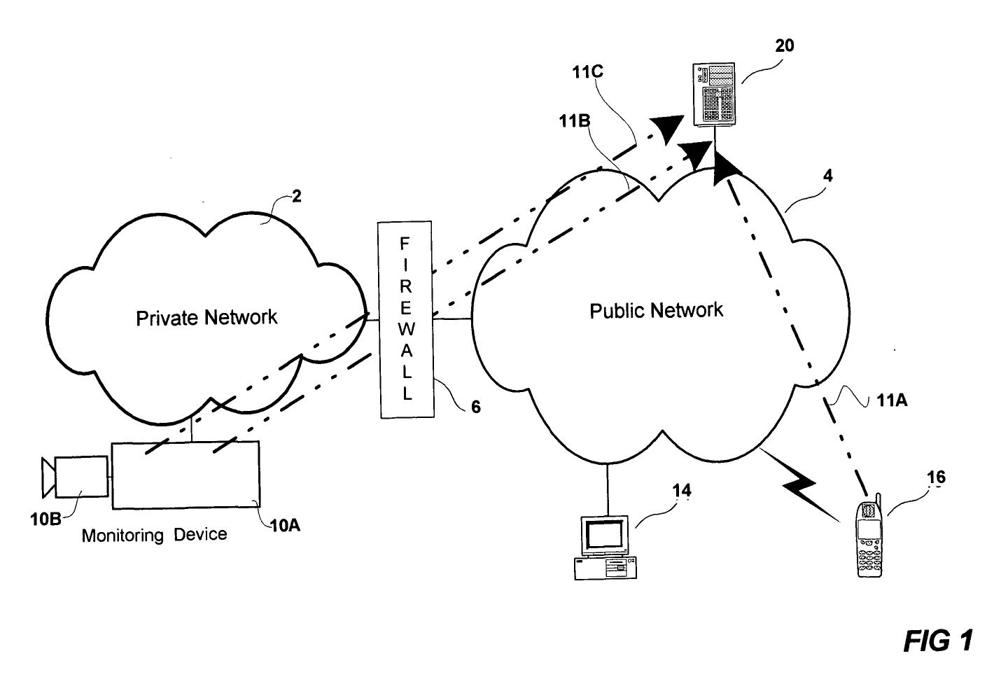

FIG. 1 is a network diagram of one embodiment of a monitoring system according to the present invention. The monitoring system includes a private network 2, e.g. a Local Area Network (LAN) arranged in a home, at an office, in a factory, in a park or a garden, at a car park, or in any area or premises that is interesting to monitor. The public and private networks are packet switched networks supporting the HTTP communication protocol. The private network 2 is connected to a public network 4, e.g. the Internet, via an access limiting device 6, e.g. a firewall, a NAT (Network Address Translation), a proxy server, an ISP (Internet Service Provider) providing dynamic addresses. The access limiting device 6 is limiting the access to the private network 2 from the public network 4 in different ways depending on the specific type of limiting device. For example, a firewall is generally arranged to prohibit access to devices in the private network from a public network.

Further, the system includes at least one monitoring device 10A-B. The monitoring device in this embodiment of the invention comprises a monitor component 10B, e.g. a camera, and a network component 10A. The monitor device is associated with a specific area or a process, connected to the private network 2 for providing monitoring information via the private network. The monitoring device 10A-B is arranged to be controlled by a user by means of a terminal 14, 16. The monitoring device may, for example, be a camera, a central unit of an alarm system, an IR-detector, a temperature sensor etc., which is enabled to communicate over the private network 2. The terminal 14, 16 may be a computer 14, a workstation 14, a computerized control center, a mobile telephone 16, a PDA (Personal Digital Assistant), etc. and is connected to the public network 4.

As mentioned above the access to the monitoring devices on the private network 2 from devices on the public network 4 is barred by the access limiting device 6. A virtual connection is required for the user at either terminals 14 or 16 to control the monitoring device. The virtual connection requires three underlying HTTP connections, which are shown in FIG. 1 as connections: 11A, 11B, 11C. This should be enabled without affecting the available bandwidth on the network to any greater extent and, thus, this function should not involve unnecessary usage of bandwidth. To make user access to the monitoring device's data possible, a control connection from the server 20 to the monitoring device 10 through the access limiting device is set up by making the monitoring device 10 send a HTTP request 52 to the control server 20 for the transfer of the file, thus opening the first connection 11A. The second connection 11B is initiated by a sign in or registration request by the monitoring device to the control server which is maintained in an open path/connection condition. Over this open connection the control server sends a plurality of responses at least one of which includes an embedded monitor control message (MCM) which indicates which file on the monitoring device is requested by the user. The third connection 11C is also opened by an HTTP request from the monitoring device to the control server as a result of the receipt of the MCM, for the upload of the requested file or data to the control server. If the round trip latency is low enough the control server completes the delivery of the uploaded file to the terminal server, in a response over open connection 11A to the terminals initial data transfer request, thus allowing the transfer to be accomplished in a single ‘virtual session’. In an alternate embodiment of the invention the response portion of connection 11C can also be used to download data such as monitor configuration data to the monitoring device from the control server. In still another embodiment of the invention the third connection 11C can be opened between the monitoring device and any other network accessible device not shielded by an access limiting device. The file or data transferred to the terminal may be image or other data types captured by the, audio, electronic, video, electrical, chemical or other type of monitoring device. Alternately the file or data transferred may be configuration data for the monitoring device itself.

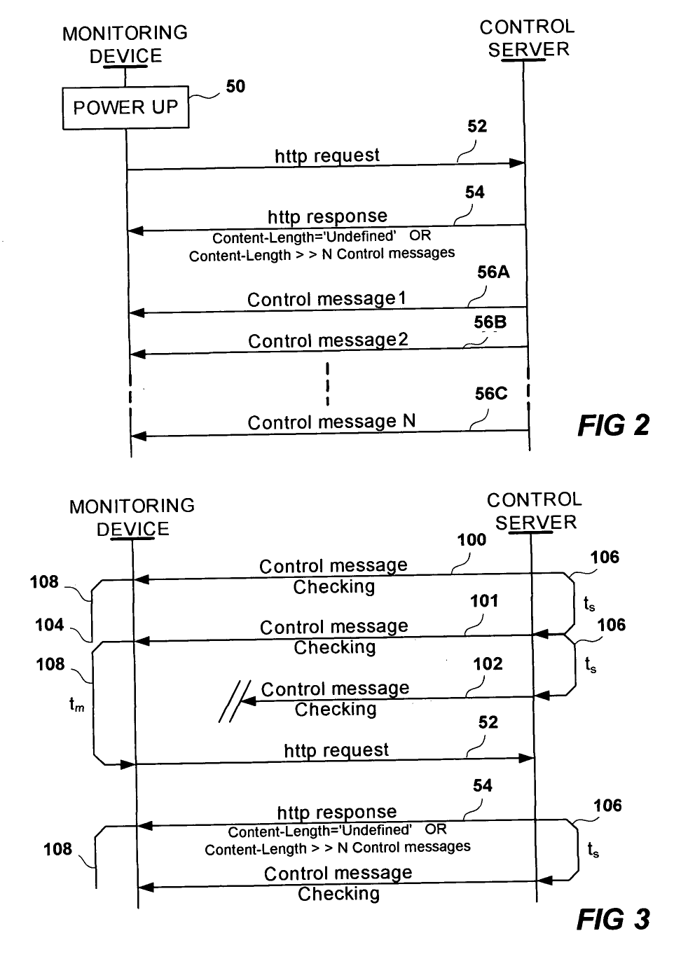

FIG. 2 is a timing diagram of one embodiment of the signaling between the monitoring device and the control server resulting in the open path there-between. The phrases ‘open path’ and ‘open connection’ as used throughout the specification, drawings and claims are synonymous with one another. In the HTTP protocol a connection is open if a request has been made and a response has not been delivered. The sending of an HTTP request by the monitoring device to a control server may occur in alternate embodiments of the invention: upon power up 50 of the monitor device; upon detection of a network connection by the monitoring device; upon pressing a button or keying a code on the monitoring device; upon receipt of detection event by the monitoring device indicating an alarm condition, etc. An event indicating an alarm may be a signal generated internally by the monitoring device or received by the monitoring device from an external source. A sensor or a state in a program may trigger the alarm.

The control server 20 then respond to the HTTP request 52 by sending an “endless” HTTP response 54 to the monitoring device 10. The length of the content of the endless HTTP response 54 is not specified or may be specified as a large number in the HTTP response and, thereby, the underlying TCP connection is not terminated by the control server. This results in that the access limiting device 6 and the monitoring device 10 do not consider the response terminated and, thereby, an open path from the control server 20 through the access limiting device 6 and to the monitoring device 10 is created. In the case of the content length being specified as a large number, the response is not terminated until the amount of data corresponding to the large number has been sent. The control server utilizes the open path to control the monitoring device 10 by sending monitor control messages (MCM) 56A, 56B, 56C to the monitoring device, wherein N is an unlimited number. The MCMs may be initiated by the control server 20 itself or by a user terminal 14, 16. As a result of the open path the control server 20 is able to send MCMs 56 at any time, i.e. the server does not have to wait for any polling signal from the monitoring device and, thus, there is essentially no latency. Accordingly, a user requesting monitoring data from a monitoring device 10 using a user terminal 14, 16 would only experience the latency resulting from the transport of the request, the processing in the monitoring device and the transport back to the terminal. This also results in less traffic being transported in the network.

The HTTP response from the control server to the monitor requesting a session with the control server initiates the open path. The HTTP response includes a plurality of MCMs 56A, 56B, 56C dispersed in time. In an embodiment of the invention the ‘Content-Length header field of the HTTP response header is set to a number that is large enough to enable transport of a plurality of future MCMs as part of an over time stretched HTTP response. This time stretched response may be achieved by not assigning a value to the ‘Content-Length’ field of the HTTP response header or by setting the length of the content of the HTTP response to a large number. In the case of setting the length of the content to a large number, the large number is to be selected so large as a plurality of MCMs 56A, 56B, 56C may be sent by means of the HTTP response from the content server without termination of the HTTP response and consequently the open path. In some cases such a large number may be 18 kilobytes, if the initial packet of the HTTP response only is some bytes and if the subsequent MCMs also are rather small. However, such a large number may also be two megabytes or greater if the MCMs are of larger size. Additionally, the size of the length of the content also depends on the desired duration of the open path. In some applications the network load is not much affected if a new open path is set up once every hour, but in other applications it may be desirable to keep the open path open for a day or more in order not to noticeably affect the network load.

Accordingly, the open path is the communication link into the private network 2 for control server 20 or terminal 14, 16 initiated messaging, as depicted by the MCMs 56A, 56B, 56C in FIG. 2. The MCMs from the content server may be utilized to control the monitoring device from a terminal of the user. Instructions sent by a user from a terminal to a control server, are relayed or translated by the control server and sent via the open path by the control server to the target monitoring device. Further, the MCMs 56 may be utilized to check the status of the monitoring device 10, to test that the monitoring device is operating correctly, to control the status of the open path connection, to provide configuration data to the monitoring device, to request the monitoring device 10 to set up a new or other connection or to request the monitoring device to deliver data, e.g. monitoring data or other data of interest, to a specific destination.

In one embodiment the control server 20 is arranged to frequently initiate a check of the open path connection in order to determine if the connection has been broken or for any reason terminated. The check is initiated by the control server which sends a MCM 56, including instructions and data associated with the check, via the open path. The monitoring device is programmed to expect frequent reception of such a MCM.

FIG. 3 is a timing diagram showing an embodiment of a signaling protocol for checking the open path between the control server and a monitoring device. Such a check may be implemented in many different ways. For instance the control server may be provided with a MCM timing interval 106 the expiration of which triggers the sending of the MCM 100, including check data. The duration of the server's MCM timing interval is identified as tₛ. The monitoring device may also be provided with a MCM timing interval 108 identified as tₘ. A hardware or software countdown timer may be utilized to effect interval timing on either or both the monitor device and control server. The monitor's MCM timing interval 108 is reset 104 each time the monitoring device receives an MCM 100, 101, 102. Each MCM may include control data. The time period set for the monitoring device may be tₘ, wherein tₘ=tₛ+Δt. The interval Δt is a short time period in relation to tₛ, this time period Δt only has to be long enough to compensate for possible delays in transmission of the MCM from the control server to the monitor device.

In FIG. 3 there is shown a MCM 100 including checking data. At the same time as the MCM 100 is sent the MCM timing interval 106 is started. When the MCM 100 is received at the monitoring device the MCM timing interval 108 at the monitoring device is started. Then, tₛ time units after the MCM timing interval 106 of the control server was started the expiration of the MCM timing interval triggers the sending of the next MCM 101, including any checking data, and the MCM timing interval 106 of the control server is restarted. When the MCM 101, including checking data, is received at the monitoring device the MCM timing interval 108 at the monitoring device is reset and restarted, before it has timed out. Then, tₛ time units after the MCM timing interval 106 of the control server was restarted the expiration of that interval triggers the sending of the next MCM 102, including checking data, and the MCM timing interval 106 of the control server is restarted once more. In this example the MCM 102 does not reach the monitoring device for some reason and this leads expiration of the monitor's MCM timing interval 108 after tₘ time units. When this timeout/expiration occurs the monitoring device sends a new HTTP request 52 in order to try to re-establish via response 54 the open path between the control server and the monitoring device. If the control server is down or the HTTP request is not arriving at the control server the monitoring device may try to connect to another control server, e.g. in a manner as described in this description.

The check may be performed once every 2 minutes in order not to load the network to the extent that the check is decreasing the capacity of the network, i.e. tₛ=2 minutes. However, the check may be performed more frequently, e.g. once every 20 seconds (tₛ=20 seconds), if the check does not result in a load decreasing the capacity of the network noticeably.

According to one embodiment of the invention an address for the control server 20 is stored in the monitoring device 10 and the address is used by the monitoring device 10 when sending the HTTP request for setting up the open path for the MCMs described above in relation to FIG. 2. The address may be an IP address (Internet Protocol address) or an URL (Uniform Resource Locator). This embodiment may be used independently of how many control servers there are available on the public network.

Independent of embodiment the final responsibility for the open path lies in the monitoring device, because the open path may only be initiated from the monitoring device. Accordingly, if the connection is broken, for some reason, the monitoring device has to initiate the setup of a new connection.

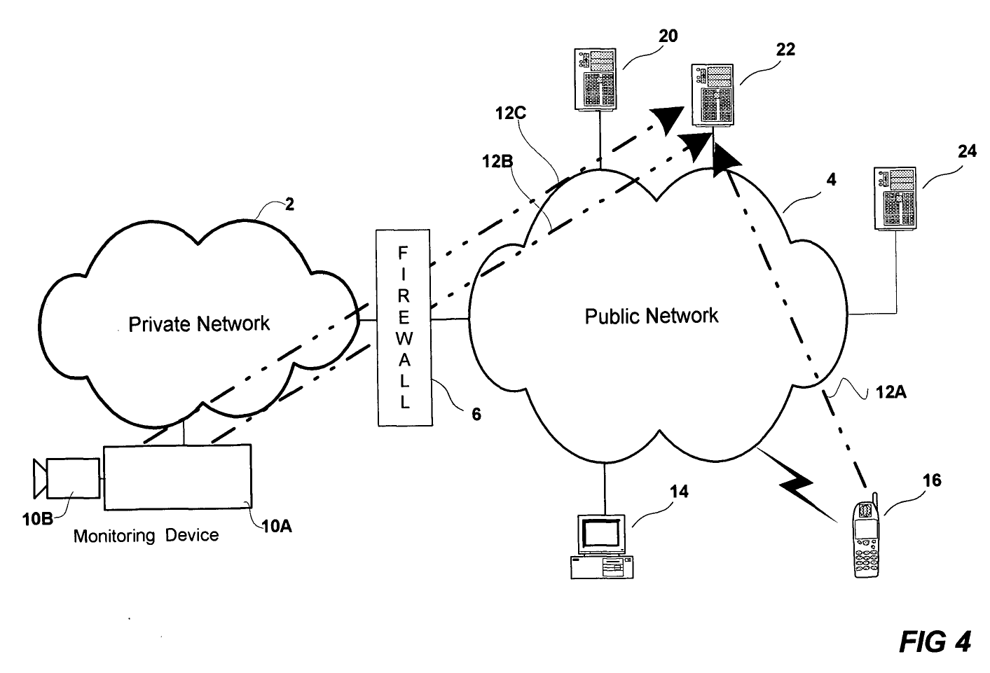

FIG. 4 is a network diagram of an alternate embodiment of a monitoring system shown in FIG. 1 which includes a plurality of control servers 20, 22, 24. The monitoring system is identical to the system presented in FIG. 1 with the difference that it includes control servers 20, 22 and 24. The monitoring device 10 may be arranged to send the initiating message to one of the control servers 20, 22, 24 in accordance with the description above or in accordance with any of the descriptions below. In the figure there is shown three control servers 20, 22, 24. However, the system may only any number of control servers. Depending on the circumstances it may be optimal to provide more than four control servers to the monitoring system.

In this embodiment a change of the control server associated with the monitoring device includes sending of a MCM from the present control server 20, i.e. a first control server 20, to the monitoring device 10A-10B including a request to terminate the connection to the first control server 20 and initiate a connection to an address provided in the MCM, which may be the address of the control server 22. Then the monitoring device 10 terminates the connection, including the open path, to the first control server and sends an HTTP request to the address for control server 22 as provided by the first control server. When the control server 22 receives the HTTP request from the monitor device, it sets up the open path in accordance with the description of FIG. 2. This allows a virtual connection to be established between the terminal 16 and the monitoring device 10A-10B over connections 12A, 12B, 12C as discussed above in connection with FIG. 1.

One advantage of providing a plurality of control servers and the method of changing control servers is that it makes it possible balance the load of different parts of the network. Another advantage is redundancy of control servers, i.e. a control server may always be available even if some are not available. A control server may be unavailable because of overload, because it is out of order, because of interrupted network connection, etc. Yet, another advantage may be the use of specialized control servers. For instance, one subset of control servers may be specialized in handling video and one subset may be specialized for other purposes. In this way there is no need to pay for licenses relating to some specific functions, programs or hardware for all control servers.

In another embodiment of the invention a plurality of control server 20 addresses are stored in a list in the monitoring device 10A-10B. The addresses in the list are prioritized, i.e. there is a first choice address, a second choice address, etc., the number of addresses in the list are equal to or less than the number of control servers 20 on the public network associated with the monitoring system. In this embodiment the monitoring device is arranged to make the initial HTTP request to the control server 20 that is the first choice according to the list in order to establish the open path from the control server 20, i.e. the first control server 20, to the monitoring device. If this attempt fails the monitoring device is arranged to make the initial HTTP request to the control server 22 which is the second choice according to the list. If there are more failures with the initial HTTP request and if there are additional control servers in the list the procedure may continue until there is no further control servers or the open path has been established.

Further, assume the open path was established by the first control server 20, but the load on the control server or the portion of the public network that the first control server is connected to is too high. Then the first control server may send a MCM to the monitoring device requesting it to connect to the second control server 22 by requesting the monitoring device to change control server. The monitoring device then terminates the connection and sends the initial HTTP request to the second choice in the list stored in the monitoring device 10.

By implementing said prioritized list of control servers in the monitoring device there is less risk that a monitoring device is not able to connect to a control server as a result of one specific control server not being currently available. Additionally, less data need to be sent to the monitoring device 10 when a change of control server is needed because of high load, thus, minimizing the contribution to the high load condition.

When a change of server has been made for a monitoring device 10 including a prioritized list, the prioritized list may be amended. The second control server 22 may, for example, be entered as the control server of first choice and accordingly the first control server is entered as a control server of lower priority. The amended list is then stored in the monitoring device 10. The advantage of such an amendment of the prioritized list is that if the monitoring device is powered down or disconnected from the network and then powered up or reconnected to the network the setup sequence of the open path does not have to be performed towards a control server that possibly still is experiencing a high load but to the same control server from which the latest open path was established successfully.

A redirecting message, including instructions ordering the monitoring device to connect to another control server, may be provided in a MCM or in the HTTP response initiating the open path.

According to one embodiment the monitoring device is a network enabled camera. In cases of the monitoring device being a camera the load balancing becomes even more important because of the large amount of monitoring data, i.e. a video sequence, images, streaming video, etc., it may send to the control server upon request and, thus, introducing large loads to the portion of the public network where the control server is connected or to the control server itself.

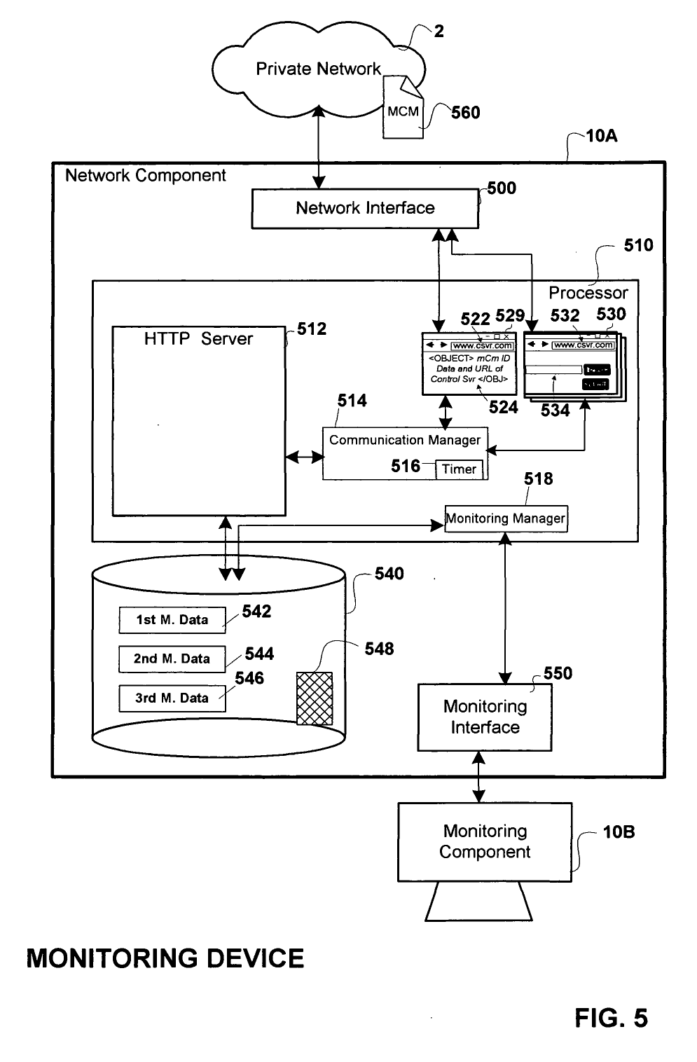

FIG. 5 is a hardware and software block diagram of one embodiment of the monitoring device. The monitor component 10B is coupled to the network component 10A which is in turn coupled to the private network 2. (See FIGS. 1 and 4) A web page 560 with an embedded MCM is shown being delivered to the monitor device across the private network. These components may be integral with one another or discrete from one another depending on the application. The network component 10A of the monitoring device includes: a network interface 500, a processor 510, storage 540 and a monitor interface 550. Storage 540 includes program code 548 and execution of which by the processor generates an HTTP server 512 with web, application and database tiers therein. The program code also includes additional functionality an execution of which generates a monitor manager 518 and a communication manager 514. The monitor manager handles setup and configuration of the monitor as well as data transfer from the monitor component to storage 540 via the monitor interface. The communication manager handles the initiation of the open path between the monitor device and one or more control servers as well as subsequent communications there between. The communication manager effects communications with a target control server via one or more web client instances which it spawns as required. For purposes of exposition these web client instances are shown as a traditional web browser, e.g. web browsers 529 and 530 with address bars 522, 532 showing target URLs ‘www.csvr.com’ which is the URL of the target control server. Since the processes effected by these browsers are totally automated, their graphical display and other user interface related capabilities shown here to simplify the exposition are not required in a preferred embodiment of the invention. In alternate embodiments of the invention each web client instance may be realized with a series of system or library calls in C, C++, JAVA or other program language, rather than a browser.

The non-volatile web client/browser instance 529 spawned by the communication manager handles delivery of a HTTP request to a target control server, and the parsing and forwarding of subsequently delivered MCMs 524 to remaining portions of the communication manager for execution. Each MCM is embedded in the body, a.k.a. web page, portions of the responses from the control server, in tag delimited or other predefined format. An interval timer 516 may be implemented to assure timely reopening of this web client instance in the event it fails. The remaining volatile web client/browser interfaces 530 are spawned by the communication manager as needed to deliver requested monitor data 542, 544, 546 from storage 540 after which the connection is closed. The browser instance 530 is shown with browse and submit functions to locate the requested file/data on storage 540 and to submit it via an HTTP POST to the control server associated with the URL shown in address bar 532. Once again a preferred embodiment of the invention does not require that the web client instances include graphical display capability since file name, browse, and submit functions are all automated by the communication manager.

The HTTP server 512 and the communication manager 514 may be implemented as software functions processed by a processor of the monitoring device, but may also be implemented by means of hardware. The communication manager 514 is arranged to send the initial HTTP request for setting up the open path and to parse and execute MCM received via said open path on the HTTP server 512. The monitoring device and, thus, the communication manager and the HTTP server are connected to the private network 2, via the network interface 500. The HTTP server handles the HTTP requests by either loading or storing data in the URL addressable storage means 540. The URL addressable storage means may include a URL for first monitoring data 542, which may be one type of data generated by the monitor component 10B, a URL for second monitoring data 544, which may be another type of data generated by the monitor component, and an URL for configuration data 546. Monitoring data may, for example, be video images or sequences.

According to another embodiment the monitoring device additionally may include a media server implementing RTSP (Real Time Streaming Protocol) or the HTTP server may be replaced by such a media server.

An embodiment of a method to request monitoring information from a monitoring device 10A-10B by means of a terminal 14, 16 by referring to FIG. 1 will now be described. The method may be used in systems comprising a plurality of control servers 20, a plurality of monitoring devices and a plurality of terminals as well as in a system as depicted in FIG. 1. The open path between the control server 20 and the monitoring device 10A-10B has been set up in accordance with the description of FIG. 2.

The user of the terminal 16 decides that he wants monitoring data from a specific monitoring device. The terminal 16 sends an HTTP GET/POST to the control server 20 specifying the wanted data. The control server 20 receives the HTTP GET, assigns the connection established by the HTTP GET from the terminal a session identity, and translates the HTTP GET/POST to a MCM for sending via an open path to the specified monitoring device. The MCM includes a command specifying the action to be taken, in this example the action is to retrieve data, a URL identifying the data to retrieve and a destination URL, specifying an address at a control server 20 to which the data is to be returned and specifying the session identity. The MCM is sent to the monitoring device and the monitoring device performs the specified action by retrieving the monitoring data identified by the URL identifying the data to retrieve. The monitoring device then generates an HTTP POST directed to the destination URL included in the MCM which is the URL of the control server 20. This results in the data being sent to the control server 20. The control server receives the HTTP POST including the monitoring data. Then the control server 20 uses the session identity of the URL in the HTTP POST from the monitoring device 10 to generate a response to the HTTP GET/POST get from the terminal 16 including the requested data.

The monitoring device may include a program that interprets the MCM sent from the control server in the example above. Such a program may be arranged to identify the action to perform, in the above case to retrieve data, and then translate the URL identifying the data to retrieve to a location within the monitoring device from which the requested data is retrievable. Then the requested monitoring data is included in a HTTP POST message sent to the destination URL, as described in the above example.

According to another embodiment the monitoring device may be a monitoring device that is designed as the one described in FIG. 5. When such a monitoring device is used in the example of retrieving monitoring data above, the monitoring device receives the data of the MCM, at the communication manager 514, and translates the data to an HTTP GET/POST to the URL identifying the data to retrieve. The HTTP GET is then sent to the embedded HTTP server 512. The HTTP server then handles the HTTP GET in a way known to the person skilled in the art and returns the requested monitoring data to the communication manager 514 which generates and sends an HTTP POST, including the monitoring data, to the destination URL.

In one embodiment the monitoring device 10A-10B is provided with an electronic serial number identifying the device. The serial number may be stored in the monitoring device during manufacturing and may be used to identify the monitoring device during the setup of the connection resulting in the open path.

Additionally, the monitoring device may be provided with a unique key for encrypting messages to be sent or for decrypting received messages. This key may also be utilized to authenticate the camera during the setup of the connection resulting in the open path. The control server is also provided with a key in order to be able to decrypt messages from the monitoring device, to encrypt messages sent to the monitoring device and to authenticate the monitoring device 10A-10B. Thereby all communication between the monitoring device and the control server may be encrypted. Preferably there is provided a unique key for each monitoring device produced and the key may be stored in the monitoring device during manufacturing of the device. The keys may be keys of a shared secret system or a public key system.

According to one embodiment a very large list of different keys are generated before the manufacturing of the cameras which are to be provided with these keys. The list should be of such a size that no new list has to be generated for years. Each control server is provided with the list of keys and during the manufacturing of a monitoring device the device will be provided with one of the keys. By providing the keys in this way there is no need for distribution of keys, which may be a safety hazard. Accordingly, authentication of monitoring devices and the distribution of keys may be simplified.

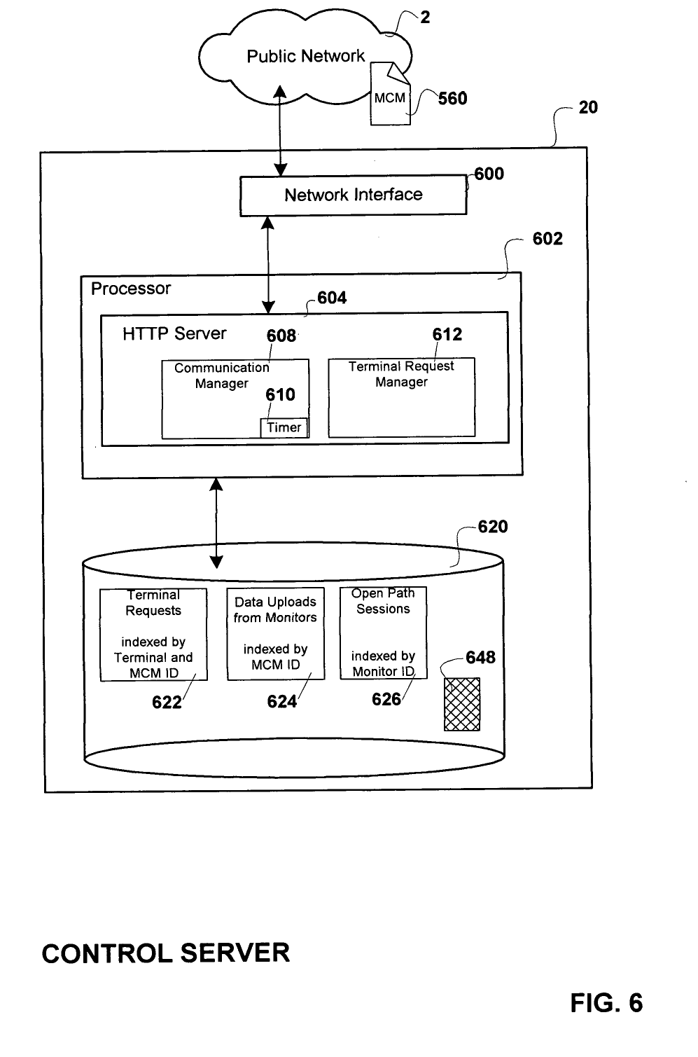

FIG. 6 is a hardware and software block diagram of one embodiment of the control server. The control server 20 and network 2 are shown. The outgoing MCM 560 is shown. The control server 20 includes a network interface 600, a processor 602 and storage 620. Storage includes program code 628 an execution of which by the processor effects an HTTP server 604, a communication manager 608 and a terminal request manager 612. The terminal request manager handles communications with one or more terminals requesting data from a monitoring device and the delivery of such data thereto. Requests for monitor data received from a terminal are stored by the terminal request manager as terminal request records 622. Data uploaded from a monitor device via the communication manager 608 is stored in data upload records 624. The terminal request manager handles the delivery of each record to the requesting terminal. The communication manager also handles all open path sessions with each monitor device which has registered with it and stores each sessions status and other information in a session record 626.

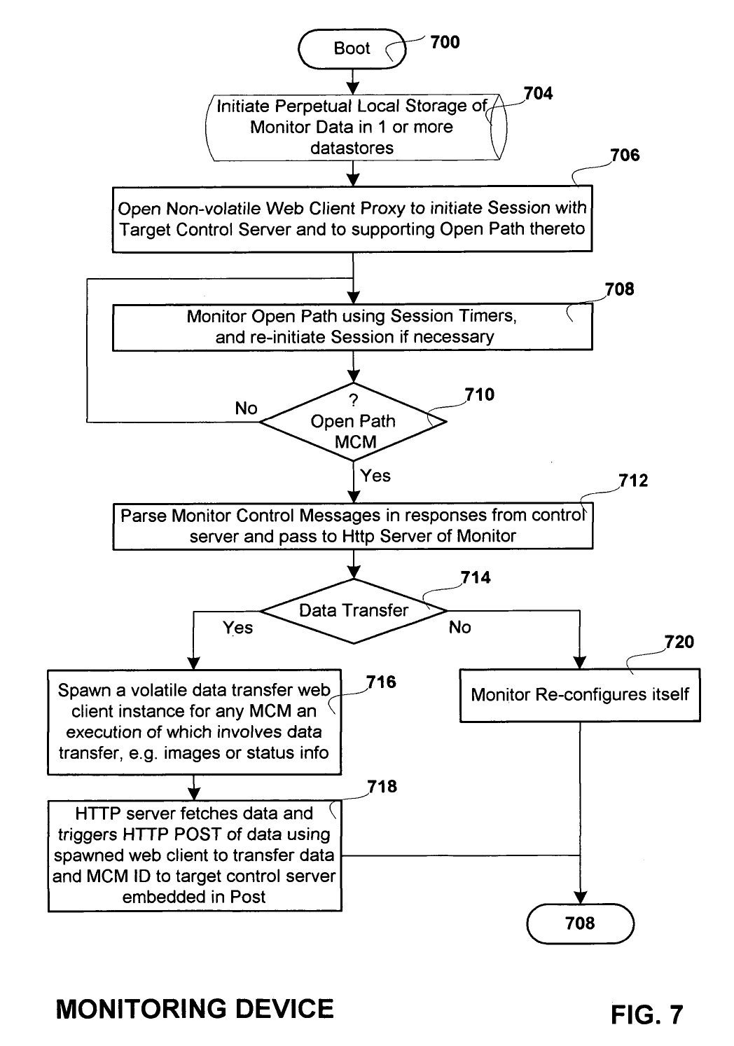

FIG. 7 is a process flow diagram of the processes executed in an embodiment of the monitoring device shown in FIG. 5. After the boot sequence 700 is complete control passes to perpetual storage process 704 in which the temporary storage of data from the monitor component is initiated. Next control passes to process 706. In process 706 the communication manager generates a non-volatile web client proxy instance and makes a registration/sign in request with the target control server. This non-volatile web client instance supports the open path on the response portion of which the control server sends MCM to the monitor device. Then in process 708 that open path is monitored using session timers as discussed in connection with FIGS. 2-3. Control then passes to decision process 710 in which a determination is made as to receipt of a MCM from the control server. If no MCM is received control returns to process 708. Alternately, if an MCM has been received the MCM is parsed from the body of the response from the control server and passed to the HTTP server of the monitor for execution.

Next in decision process 714 a determination is made as to whether the execution of the MCM will result in a data transfer or not. If only a monitor reconfiguration is called for then control passes to process 720 in which such reconfiguration is effected, after which control returns to process 708. Alternately if execution of the MCM calls for a data transfer control passes to process 716. In process 716 the communication manager of the monitor spawns a volatile web client instance to effect the data transfer from the monitor to the control server called for in the MCM. A data transfer can involve either the transfer of monitor status data or sensor data retrieved by the monitor component. Control passes to process 718 in which the HTTP server fetches the data and triggers an HTTP POST of the data requested in the MCM and the ID of the requesting MCM by the spawned client to the target control server. Control then returns to process 708.

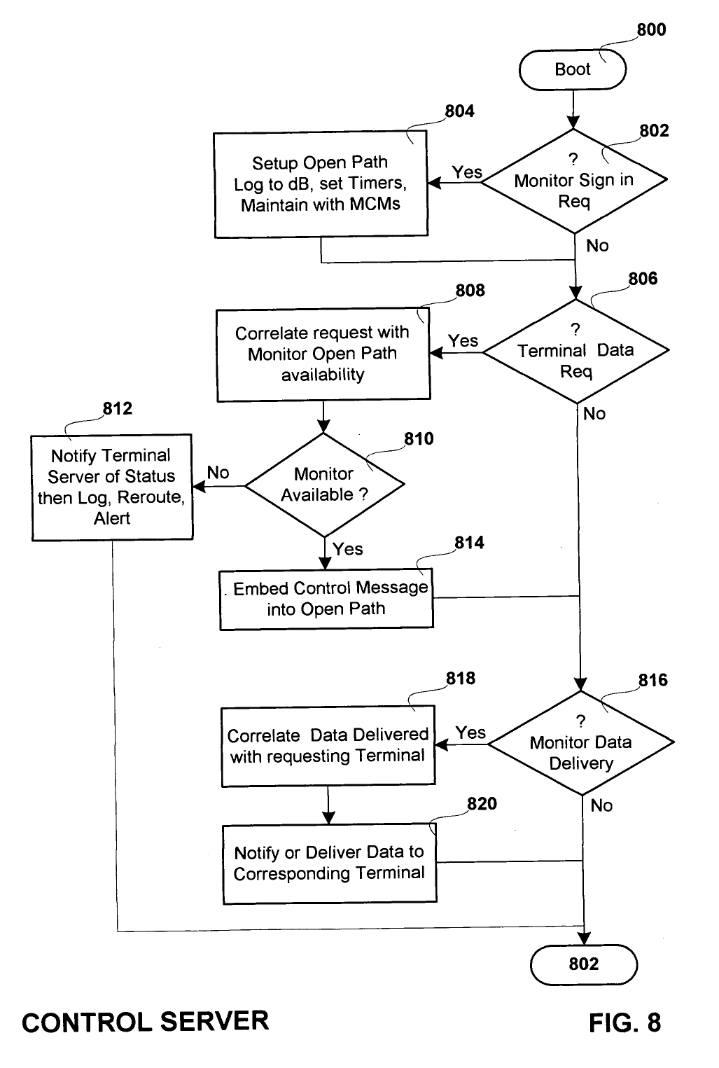

FIG. 8 is a process flow diagram of the processes executed in an embodiment of the control server shown in FIG. 6. After the boot sequence 800 is complete control passes to decision process 802 in which a determination is made as to whether a monitor registration sign in request has been received. If it has, control passes to process 804. In process 804 the open path is setup and logged into storage as a corresponding open path session record. Timers are set which assure that MCMs are sent to the monitor device at intervals which sustain the open path between the control server and the monitor device. Next control passes to decision process 806.

In decision process 806 a determination is made as to whether a data request from a terminal has been received. If not control passes directly to process 816. If a terminal data request has been received control passes to process 808. In process 808 the terminal request is correlated with the ID of the monitor device on which such data is stored and the availability of an open channel therewith. If there is no open path as determined in decision process 810 then control passes to process 812. In process 812 the Terminal is notified of the unavailability of the Monitor device. In an embodiment of the invention the notification may also include the URL of an alternate control server which does have an open path to the subject monitor device. This redirect allows the terminal to fetch the data via another control server. Control then returns to process 802. Alternately if the monitor device is available as determined in decision process 810 then control passes to process 814. In process 814 a MCM is embedded into the body of a HTTP response from the control server over the open path with the monitor device. The MCM will identify the action to be taken, e.g. reconfiguration or data transfer, the name of the file to be transferred and the ID associated with the message. Control then passes to decision process 816.

In decision process 816 a determination is made as to whether a data delivery has been received from a monitor over one of the volatile web client/browser instances spawned by the monitor device. If it has then control passes to process 818. In process 818 the communication manager correlates the data delivered with the terminal which requested the data using the terminal data request records which are maintained by the communication manager. Once the data is correlated with a requesting terminal the data or notification thereof is delivered in an HTTP response by the control server to the terminals outstanding request. Control then returns to process 802.

The foregoing description of a preferred embodiment of the invention has been presented for purposes of illustration and description. It is not intended to be exhaustive or to limit the invention to the precise forms disclosed. Obviously many modifications and variations will be apparent to practitioners skilled in this art. It is intended that the scope of the invention be defined by the following claims and their equivalents.

What is claimed is:

1. A monitoring system configured to couple to a packet switched network supporting an HTTP protocol and the monitoring system comprising:
a control server configured to couple to the packet switched network and to respond to a sign in request from a monitoring device by maintaining an open connection therewith and further configured to respond to a data request from a network terminal for monitoring data from the monitoring device by sending over the open connection a response packet including a control message portion which includes an uniform resource locator identifying the monitoring data; and
the monitoring device configured to couple to the packet switched network and to send the sign in request to the control server and the monitoring device responsive to the receipt of the response packet from the control server to parse the control message portion and to open a new data transfer connection with the control server by sending an HTTP request which includes the monitoring data to the control server, whereby the requested monitoring data is uploaded to the control server for delivery to the terminal without a requirement of an HTTP request from the control server to the monitoring device.

2. The control server of claim 1, further configured to inject into an HTTP header portion of the response packet one of:
an HTTP ‘Content-Length’ field having a null value; and
the HTTP ‘Content-Length’ field having a non-null value substantially exceeding an actual content length of the response packet;
thereby extending a duration of the open connection with the monitoring device beyond a time of sending of the response packet.

3. The control server of claim 1, further configured to send successive response packets to the monitoring device over the open connection therewith.

4. The monitoring device of claim 1, further configured to send the sign in request to the control server upon connection of the monitoring device to the packet switched network.

5. The monitoring device of claim 1, further comprising:
a list identifying network addresses of a plurality of control servers including the control server subject to the sign in request.

6. The monitoring system of claim 1, further comprising:
a firewall configured to couple the monitoring device to the packet switched network and to block HTTP requests to the monitoring device and to allow HTTP requests from the monitoring device to the control server.

7. The monitoring system of claim 1, wherein further the monitoring device comprises one of
a camera;
a alarm system;
an infra red (IR) detector; and
a temperature sensor.

8. An apparatus configured to couple to a packet switched network which supports an HTTP protocol and which includes a control server and the apparatus comprising:
a monitoring device configured to couple to the packet switched network and to issue a first HTTP request for sign in to the control server and the monitoring device responsive to the receipt of the response packet from the control server to parse a control message portion thereof which identifies monitoring data on the monitoring device for transfer to the control server and the monitoring device further responsive to open a new data transfer connection with the control server by sending a second HTTP request which includes the monitoring data to the control server, thereby avoiding any HTTP request from the control server to the monitoring.

9. The monitoring device of claim 8, further configured to send the first HTTP sign in request to the control server upon connection of the monitoring device to the packet switched network.

10. The monitoring device of claim 8, further comprising:
a list identifying network addresses of a plurality of control servers including the control server subject to the first HTTP sign in request.

11. The monitoring system of claim 8, wherein further the monitoring device comprises one of:
a camera;
a alarm system;
an infra red (IR) detector; and
a temperature sensor.

12. A method for transferring monitoring data over a packet switched network which includes a monitoring device, a control server and a terminal each of which supports an HTTP protocol and the method comprising the acts of:
sending from the monitoring device a first HTTP request for sign on to the control server;
sending from the terminal to the control server a second HTTP request for monitoring data on the monitoring device;
sending from the control server to the monitoring device an HTTP response to the first HTTP request which includes a control message portion identifying the monitoring data identified in the second request;
parsing the control message portion of the HTTP response packet on the monitoring device; and
sending from the monitoring device to the control server responsive to the parsing act, a third HTTP request which includes the monitoring data, whereby the requested monitoring data is uploaded to the control server for delivery to the terminal, thereby avoiding an HTTP request from the control server to the monitoring device.

13. The method for transferring monitoring data of claim 12, further comprising the act of:
sending a HTTP response to the second HTTP request which response includes the monitoring data identified in the second HTTP request subsequent to the fourth sending act, thereby allowing a virtual connection between the terminal and the monitoring device.

14. The method for transferring monitoring data of claim 12, further comprising one of the acts of
injecting an HTTP ‘Content-Length’ field having a null value into an HTTP header of the HTTP response packet sent from the control server to the monitoring device in the third sending act; and
injecting the HTTP ‘Content-Length’ field having a non-null value substantially exceeding an actual content length of the response packet into an HTTP header of the HTTP response packet sent from the control server to the monitoring device in the third sending act;
thereby extending a duration of the open connection with the monitoring device beyond a time of sending of the response packet.

15. The method for transferring monitoring data of claim 12, wherein the third sending act further comprises the act of:
sending successive response packets to the monitoring device over the open connection therewith.

16. The method for transferring monitoring data of claim 12, wherein the first sending act further comprises the acts of:
connecting the monitoring device to the packet switched network; and
sending HTTP request to sign in to the control server responsive to the connecting act.

17. The method for transferring monitoring data of claim 12, further comprising the act prior to the first sending act of:
storing on the monitoring device a list identifying network addresses of a plurality of control servers including the control server subject to the sign in request in the first sending act.

18. The method for transferring monitoring data of claim 12, wherein the first sending act further comprises the acts of:
blocking HTTP requests to the monitoring device with a firewall.
